(19) United States
(12) Patent Application Publication
(10) Pub. No.: US 2010/0018072 A1
(43) Pub. Date: Jan. 28, 2010

(54) Laundry treating apparatus

(75) Inventors: Young Soo Kim, Gyeongsangnam-do (KR); Seong Hae Jeong, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Yeongdeungpo-gu (KR)

(21) Appl. No.: 12/308,980

(22) PCT Filed: Jul. 3, 2007
(86) PCT No.: PCT/KR2007/003223

§ 371 Date: Aug. 5, 2009

(30) Foreign Application Priority Data
Jul. 4, 2006 (KR) 10-2006-0062473

(51) Int. Cl. F26B 19/00; F26B 25/06; F25B 27/00

(52) U.S. Cl. 34/86; 34/218; 62/238.7

(57) ABSTRACT

The present invention relates to a laundry treating apparatus (100) which enables supply of heated air of temperature ranges different from one another thereto, including a cabinet (10) having an inside space for holding clothing, a steam generator (20) provided to the cabinet (10) for supplying steam to the inside space (11), selectively, and a heated air supply device (40) in the cabinet (10) for making selective supply of air with at least three temperature ranges to the inside space (11).

### TECHNICAL FIELD

The present invention relates to laundry treating apparatus. More specifically, the present invention relates to a laundry treating apparatus which can supply various modes of air, and, in addition to this, steam.

### BACKGROUND ART

In general, the laundry treating apparatus includes all devices for managing or treating clothing like homes or a laundry shops, such as washing, drying, removal of creases, and so on of clothing and beddings.

For an example, the laundry treating apparatuses are washing machines for washing clothing, dryers for drying the clothing, washing and drying machines having both a washing function and a drying function, refreshers for refreshing the clothing, presses for removal of creases from the clothing, or forming pleats required for the clothing, and steamer for removal of unnecessary creases from the clothing.

The refresher, for making the clothing more comfortable or refreshing, performs functions of drying the clothing, supplying aroma to the clothing, preventing clothing from generating static electricity, removing the creases from the clothing, and so on. Many refreshers are being supplied to the North American market.

Many steamers, appliances in general merely for supplying steam to the clothing for removing the creases from the clothing, are supplied through T.V. home-shoppings, and the like, for removal of the creases from fine clothing, because, different from a general press, no hot plate is brought into contact with the clothing.

In the meantime, currently, many washing machines, particularly, drum type washing machines having steam generators, are being supplied. That is, products are spotlighted, which have washing effects maximized by supplying steam to laundry before and after the washing, or in the middle of the washing, for sterilizing, redoing a laundry wet time period, acceleration of activation of detergent, and so on.

Particularly, of the laundry treating apparatuses, though the present invention is related to the refresher, the present invention is not limited to the refresher.

A related art refresher is provided with a cabinet having a space for holding clothing formed therein. Steam is supplied to the space for removal of creases from the clothing. A source of the steam may be a steam generator in the cabinet for generating the steam, or may be a boiler on an outside of the cabinet.

### DISCLOSURE OF INVENTION

### Technical Problem

However, because the hot air supplied to the inside of the related art refresher has a high temperature, the clothing therein is vulnerable to deformation. Since materials, such as wool and silk, are susceptible to the high temperature, the refresher has a limitation in treating clothing of wool or silk.

In the meantime, though the related art clothing treating device, particularly, the refresher, heats the air with a gas burner, or an electric heater, such an air heating system has a limitation in controlling a temperature range of the hot air variously.

### Technical Solution

To solve the problems, an object of the present invention is to provide a laundry treating apparatus which enables to supply various ranges of hot air.

Another object of the present invention is to provide a laundry treating apparatus which can supply steam together with hot air for refreshing the clothing.

Another object of the present invention is to provide a laundry treating apparatus which can be used, not only for clothing of a specific material, but also for clothing of any material.

Another object of the present invention is to provide a laundry treating apparatus which can be manufactured and installed easily, and convenient to use for reducing product, and installation costs.

To achieve these objects and other advantages and in accordance with the purpose of the invention, as embodied and broadly described herein, a laundry treating apparatus includes a cabinet having an inside space for holding clothing, a steam generator provided to the cabinet for supplying steam to the inside space selectively, and a heated air supply device in the cabinet for making selective supply of air with at least three temperature ranges to the inside space.

The heated air supply device supplies air of a room temperature, and heated air of a middle temperature and a high temperature to the inside space selectively, and preferably, if the heated air supply device supplies air of the middle temperature, the heated air supply device supplies heated air of the middle temperature or dry heated air of the middle temperature selectively, and, if the heated air supply device supplies air of the high temperature, the heated air supply device supplies dry heated air of the high temperature.

In the meantime, the heated air supply device includes a housing on one side of the cabinet for making selective communication with the inside space to form a flow passage of the air, a condensing type heat pump in the housing, and a heater and a fan for heating the air flowing along the flow passage.

The condensing type heat pump includes a compressor, a condenser, an expansion valve, and an evaporator, through which refrigerant circulates, wherein the evaporator and the condenser heat exchange with the air flowing along the flow passage, and the condensing type heat pump condenses moisture in the air introduced thereto at the evaporator to remove the moisture from the air, and heats the air introduced thereto at the condenser to the middle temperature.

The laundry treating apparatus may further include a condensing water tank for collecting and holding the condensed water condensed at the evaporator, and the condensed water collected and held in the condensed water tank is supplied to the steam generator.

In the meantime, in a case the heated air is supplied to the inside space, the air introduced into the housing is heated at least by one of the condensing type heat pump and the heater before being supplied to the inside space.

In this instance, preferably, the heated air supply device puts the heater into operation when the heated air supply device supplies the heated air of the middle temperature to the inside space, if the heated air supply device supplies air of the middle temperature to the inside space, the heated air supply device puts the condensing type heat pump into operation, and, if the heated air supply device supplies air of the high temperature to the inside space, the heated air supply device puts the condensing type heat pump and the heater into operation.

The laundry treating apparatus may further include a fan for making the air to flow along the flow passage, and preferably, the fan is located at a rear end of the condenser.

The fan is operated in a case the air of the room temperature is supplied to the inside space.

In the meantime, the housing may have two or more than two outlets formed therein, and, preferably, the two or more than two outlets supply air of temperature ranges different from each other. That is, the outlets may include a first outlet for, supplying dry heated air of the middle temperature, and a second outlet for supplying dry heated air of the high temperature. Moreover, the device may further include first, and second dampers for selective opening of the first, and second outlets.

The evaporator and the condenser are located at fore ends of the first, and second outlets of the flow passage respectively, and the heater is located adjacent to the second cutlet, and the device may further include fans at the fore ends of the first, and second outlets, respectively.

In the meantime, the first damper is opened, and the condensing type heat pump and the fan are operated in a case the dry heated air of the middle temperature is supplied through the first outlet, and the second damper is opened, and the condensing type heat pump, the fan, and the heater are operated in a case the dry heated air of the high temperature is supplied through the second outlet.

The inside space may be divided into two or more than two spaces in correspondence to the two or more than two outlets, and, preferably, the cabinet has doors on opposite sides, and the inside space is divided into a plurality of spaces in correspondence to the doors.

In this instance, the heated air of the middle temperature is supplied to the space in correspondence to one side door and the heated air of the high temperature is supplied to the space in correspondence to the other side door.

### BRIEF DESCRIPTION OF THE DRAWINGS

FIG. 1 illustrates a perspective view of a clothing treating device in accordance with a preferred embodiment of the present invention, schematically;

FIG. 2 illustrates a diagram of a condensing type heat pump cycle applied to the present invention, schematically;

FIG. 3 illustrates a section of a heated air supply device in accordance with a preferred embodiment of the present invention, schematically; and

FIG. 4 illustrates a section of a heated air supply device in accordance with a preferred embodiment of the present invention, schematically.

### BEST MODE FOR CARRYING OUT THE INVENTION

Reference will now be made in detail to the specific embodiments of the present invention, examples of which are illustrated in the accompanying drawings.

The present invention relates to laundry treating apparatuses, and preferably, a cabinet type clothing refresher. Therefore, though the laundry treating apparatus described hereinafter is based on such a refresher, the present invention is not limited to this.

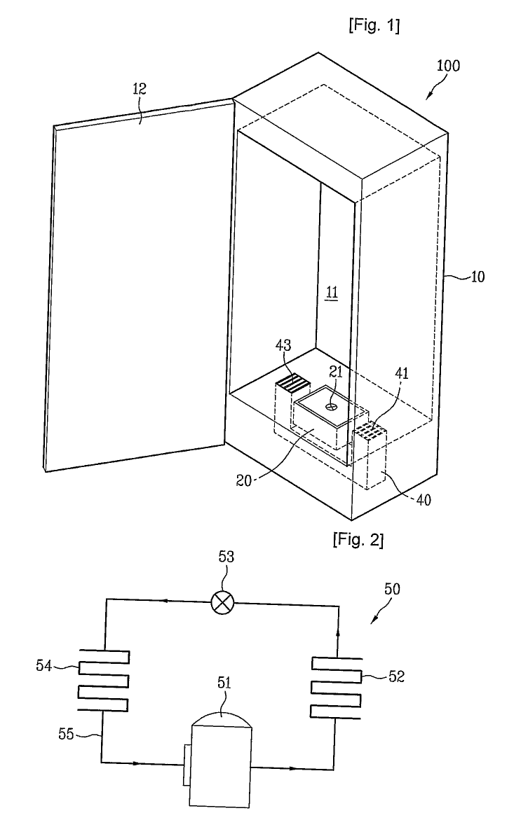

FIG. 1 illustrates a perspective view of a laundry treating apparatus in accordance with a preferred embodiment of the present invention.

Referring to FIG. 1, the laundry treating apparatus 100 includes a cabinet 10, a steam generator 20, and a heated air supply device 40.

The cabinet 10 has an inside space 11 isolated from an outside of the cabinet 10 for holding clothing, which can be in communication with the outside of the cabinet 10 through a door 12, selectively. That is, if the door 12 is closed, the inside space 11 is isolated from the outside actually, and, if the door 12 is opened, the inside space 11 is exposed to the outside. Therefore, the user opens the door 12 to place the clothing in the inside space 11, and closes the door 12 when the refresher 100 is put into operation.

The steam generator 20 is provided to the cabinet, for supplying steam to the inside space 11. Though the steam may be water vapor, it is preferable that the steam is a steam with a temperature higher than a preset temperature generated by heating water.

It is preferable that the steam generator 20 sprays the steam to the inside space 11 through a spray hole 21. It is preferable that the steam generator 20 has a water tank (not shown) for holding water required for generating the steam. The water tank may be connected to an external hydrant, or filled with water by the user, manually.

Water condensed at the condenser to be described later may be provided to the water tank.

The steam generator 20 may be provided with a heater (not shown) for heating the water to generate the steam. The heater may be a sheath heater.

FIG. 1 illustrates only one spray hole 21 for spraying steam from the steam generator 20, provided at a lower portion of the inside space 11.

However, though not shown, a plurality of the steam spray holes 21 may be provided to inside walls or upper side walls. In this case, the plurality of the steam spray holes may be connected to the steam generator 20 with steam flow passages (not shown). The steam flow passages may be provided in the cabinet or built-in the walls of the cabinet.

The steam is supplied to the clothing for refreshing. That is, the supply of steam to the clothing is effective in removing odor, static electricity, and creases from the clothing. Even a sterilizing effect is also obtainable.

The present invention further includes a heated air supply device 40. FIG. 1 illustrates the heated air supply device 40 provided to the lower portion of the cabinet 10.

The heated air supply device 40 supplies the hot air to the inside space 11 of the cabinet through an outlet 41 formed in one side. The hot air supplied to the inside space evaporates moisture from the clothing, to be turned into humid air, and is introduced into the heated air supply device 40 through an inlet 43 in the other side.

In the meantime, the heated air supply device 40 can supply air of various temperature ranges to the inside space 11. That is, air of a room temperature can be supplied, air of a middle temperature higher than the room temperature can also be supplied, and air of a high temperature can also be supplied.

That is, the heated air supply device 40 can supply air of at least three temperature ranges. The temperature ranges of the air may vary with needs, such as taking properties of clothing required for refreshing into account.

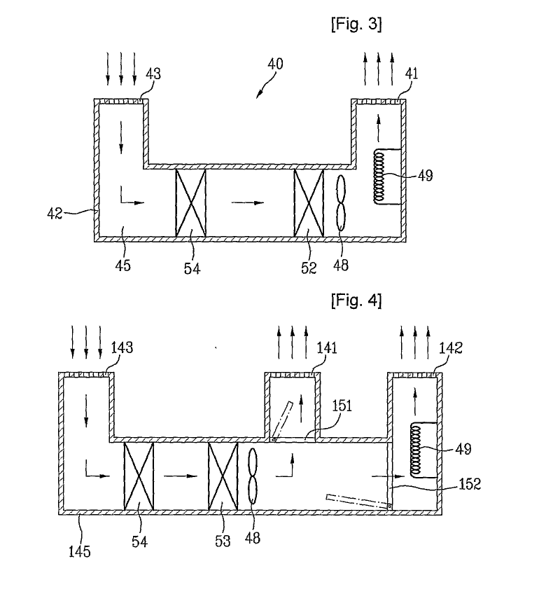

The heated air supply device 40 will be described with reference to FIGS. 2 and 3 in detail.

FIG. 2 illustrates a diagram of a refrigerating cycle of a condensing type heat pump 50, and FIG. 3 illustrates flow passages in the heated air supply device.

The present invention includes the condensing type heat pump 50. As shown in FIG. 2, the condensing type heat pump 50 has a refrigerating cycle, and the refrigerating cycle is identical to ones applied to a general heat pump or an air conditioner.

The condensing type heat pump 50 includes a compressor 51, a condenser 52, an expansion valve 53, and an evaporator 54. These are connected with one another with a refrigerant flow passage 55. Refrigerant flows in the refrigerant flow passage, and heat exchange is made with an environment by changes of a pressure, a temperature, and a phase of the refrigerant.

In more detail, gaseous high temperature, low pressure refrigerant vaporized at the evaporator 54 is introduced to, and compressed at, the compressor 51. Therefore, high temperature, and high pressure refrigerant is introduced to the condenser 52. The refrigerant is condensed into liquidus low temperature, and high pressure refrigerant at the condenser. In this instance, the refrigerant dissipates heat to an environment as the refrigerant is condensed. The liquids low temperature, and high pressure refrigerant condensed at the condenser is introduced to, and turned into low temperature, and low pressure refrigerant at, the expansion valve 53, and introduced to the evaporator 54. The low temperature, and low pressure refrigerant absorbs heat from an environment at the evaporator 54, to turn into gaseous high temperature, and high pressure refrigerant.

FIG. 3 illustrates a section of a heated air supply device 40 in accordance with a preferred embodiment of the present invention, schematically.

Of the elements of the heat pump 50, FIG. 3 illustrates the evaporator 54 and the condenser 52. As shown in FIG. 2, the evaporator and the condenser are connected to each other with the refrigerant flow passage 55, and, alikely, also connected to the expansion valve 53 and the compressor 51.

Referring to FIG. 3, the heated air supply device 40 has a housing 42 with a flow passage 45 formed therein for flow of air. That is, the air introduced thereto thrash the inlet 43 passes through the flow passage 45, and exhausts through the cutlet 41.

The evaporator 54 and the condenser 52 are provided to the flow passage 45. A fan 48 and a heater 49 may be further provided to the flow passage 45.

A location of the fan 48 is not limited to a specific location of the flow passage 45.

However, it is preferable that the fan 48 and the heater 49 are located between the condenser 52 and the cutlet 41 for enhancing air flow efficiency. It is more preferable that the heater 49 is provided between the fan 48 and the outlet 41.

Various modes of air can be supplied to the inside space 11 of the cabinet if the air is passed through the heated air supply device 40.

If only the fan 48 is put into operation in the heated air supply device 40, air of a room temperature will be supplied to the inside space 11. That is, only the air of the room temperature will circulate between the inside space 11 and the heated air supply device 40.

In the meantime, if only the fan 48 and the heater 49 are put into operation in the heated air supply device 40, heated air of the middle temperature which is higher than the room temperature will be supplied. It is preferable that the heater has a capacity smaller than a heater in a general dryer.

In this instance, the middle temperature is a range of temperature in which no deformation of fine fabric takes place, i.e., a range of 50-75 degrees C. Accordingly, the capacity of the heater will be adequate if the heater can generates the heated air of the middle temperature, taking a capacity of the fan into account.

However, in this case, though supply of the heated air of the middle temperature is possible, it will be difficult to supply heated air of the middle temperature having moisture removed therefrom the air, because no means for removing the moisture from the air is operated.

In this case, by operating only the fan 48 and the condensing type heat pump 50, supply of dry heated air of the middle temperature will be possible. In order to make a distinction between the heated air having no moisture removed therefrom and the heated air having moisture removed therefrom, the heated air having moisture removed therefrom will be called as dry heated air.

The air passed through the condenser 52 has a temperature lower than air heated at a dryer of general electric heater or a gas burner. That is, preferably, as described before, heated air in a range of 50-75 degrees C. is obtainable.

The heating of the air with the heat pump enables to improve a heating capability by two times greater than an electric heater when the same power is consumed. Because the heat pump has a higher heat exchange efficiency between a heat source and air.

In the meantime, if the heat pump 50 and the fan 48 are driven, the moisture can be removed from the air even without separate means for condensing the moisture in the air. That is, the evaporator 54 in the condensing type heat pump 50 can perform such a moisture removing function.

Air at a certain temperature has a certain limit of an amount of water vapor the air can contain, and the lower the air temperature, the smaller the amount of saturated water vapor. Therefore, by lowering the air temperature, removal of the moisture from the air is possible.

In the meantime, the evaporator 54 absorbs heat from an environment. According to this, the air introduced to the evaporator 54 discharges heat, and is involved in temperature drop, when the moisture in the air is condensed, and is removed from the air.

Accordingly, by providing the condensing type heat pump 50, the supply of the dry heated air of the middle air temperature is made possible without providing separate means for removing the moisture from the air.

Such a dry heated air supply system has the following effect compared to the gas type or electric heater type.

Basically, the gas type burns gas for generating heat. According to this, supply of oxygen is essential. That is, by combustion of the oxygen and the gas, carbon dioxide and carbon monoxide are produced. Therefore, since the gas type requires continuous introduction of external oxygen, and continuous discharge of carbon dioxide and so on, the heated air can not be supplied in a mode of an air circulation.

Therefore, such a mode of supplying the heated air with the gas type may not be suitable to a room.

The electric heater can supply the heated air in a mode of the air circulation. However, as described before, if the gas is supplied only with the electric heater, means for removing the moisture from the air is required, separately. Such moisture removal means may be a water cooling type or a air cooling type.

However, since the water cooling requires connection to a separate water hydrant, it is not desirable that provision of connection means to the water hydrant only for the moisture removal is not desirable in view of cost and efficiency. Moreover, depending on places where the clothing treating devices are installed, such a connection of the water hydrant may not be easy.

Alikely, the air cooling type requires introduction and discharge of external air. Of curse, in this case, different from the gas type, because the external air is used merely for cooling, the external air may not be outdoor air.

However, in a case of the air cooling type too, because a separate duct and a fan are required for introduction and discharge of the air, the air cooling type may not be desirable in view of cost and efficiency.

Compared to this, the supply of the heated air with the condensing type heat pump does not require the separate moisture removal means, and is very effective compared to the foregoing gas type or electric heater type in view of energy.

Of course, the separate duct for introduction and discharge of the air can be dispensed with.

Finally, according to the present invention, supply of hot dry heated air to the inside space 11 of the cabinet 10 is possible.

For this, in the present invention, all of the condensing type heat pump 50, the fan 48, and the heater 49 of the heated air supply device 40 are operated.

That is, the air heated to the middle temperature at the condenser 53 of the condensing type heat pump 50 is heated to high temperature air at the heater 49. In this instance, it is preferable that the high temperature is higher than 90 degrees C. or, if required, higher than 100 degrees C.

In the present invention, the heater 49 is an element for elevating the middle temperature to a high temperature. Therefore, an energy can be saved compared to elevating a temperature from the room temperature to the high temperature by using the heater, only.

According to the embodiment of the present invention, it is possible to make selective supply of air of various temperature ranges to the inside space 11 of the cabinet. Particularly, it is possible to make selective supply of the heated air of the middle temperature and the high temperature.

In the meantime, in the embodiment, not only the heated air, but also steam, is supplied to the inside space 11 of the cabinet, wherein it is possible to use water condensed at the condensing type heat pump 50 as water required for the steam.

That is, water condensed at the evaporator 54 can be provided to the steam generator 20. For this, the laundry treating apparatus of the present invention may further include a condensed water tank (not shown) for holding the condensed water of the moisture in the air as a result of the heat exchange at the evaporator. Of course, such a condensed water tank may not have a tank shape without fail. That is, the condensed water may be provided to the steam generator 20 following a tube (not shown).

Especially of the laundry treating apparatuses, since the embodiment is suitable for the refresher, it is preferable that coat hangers are provided to an upper portion of the inside space 11.

Another preferred embodiment of the present invention will be described in detail.

FIG. 4 illustrates a section of a heated air supply device in accordance with a preferred embodiment of the present invention.

Different from the foregoing embodiment, in the embodiment, an outlet for discharge of the middle temperature air and an outlet for discharge of the high temperature air are provided, separately.

That is, in the foregoing embodiment, though the air is discharged through one cutlet, the air temperature becomes different selectively depending on whether the condensing type heat pump and the heater are operated or not. Accordingly, in the foregoing embodiment, it is possible to make selective supply of air having different temperatures to one space.

In the embodiment, because a first cutlet for discharging the middle temperature air and a second cutlet for discharging the high temperature air are separate, it is possible to provide a space for supplying the middle temperature air and a space for supplying the high temperature air. That is, it is similar a refrigerator provided with a refrigerating chamber and a freezing chamber separately according to temperatures of cold air supplied to the refrigerator.

Alike the foregoing embodiment, in the embodiment too, the heated air supply device 140 includes a condensing type heat pump 50 and a heater 49. The condensing type heat pump supplies heated air of a middle temperature higher than a room temperature, and the heater supplies the heated air of a high temperature.

In the meantime, the heater changes the heated air of the middle temperature provided from the condensing type heat pump to the heated air of the high temperature.

Referring to FIG. 4, the heated air supply device 140 has a flow passage 145 formed therein for circulation of air, an inlet 143 for introduction air thereto, and cutlets 141, and 142 for discharge of the air. In this instance, the dry heated air of the middle temperature is discharged through the first outlet 141, and the heated air of the high temperature is discharged through the second cutlet 142. Preferably, the outlets provide the air to spaces different from each other.

A flow for supply of air of the middle temperature to a particular space will be described.

The air from the first cutlet containing moisture of the space is introduced into the inlet 143. The air then passes through, and has the moisture removed therefrom at, the evaporator 54. Then, the air passes through, and is turned into the dry heated air of the middle temperature at, the condenser 53. Then, the dry heated air of the middle temperature passes through, and is turned into the heated air of the high temperature, at the heater 40, and is supplied to the particular space through the second outlet 142 again.

The air flow can be formed by one fan 48 in the flow passage 145.

In this case, in order to supply both the air of the high temperature and the middle temperature to an inside of the one clothing treating device, all of the fan 48, the condensing type heat pump 50, and the heater 49 are operated.

In the meantime, only the air of the high temperature or the middle temperature may be supplied only to the particular space of the inside of the one laundry treating apparatus. In this case, it is preferable that a first, and second dampers 151 and 152 are provided to the flow passage for selective opening/closing of the first, and second outlets 141, and 142.

That is, when the one fan 48 is driven, the air will be discharged both through the first, and second cutlets 141, and 142. Therefore, by operating the heat pump, leaving the heater stationary, and closing the first damper 151 which opens/closes the first outlet 141, the dry heated air of the middle temperature can be provided.

By operating the heat pump and the heater, and closing the second damper 152 which opens/closes the second cutlet 142, the dry heated air of the high temperature can be provided.

Since the condensing type heat pump 50 is in operation in any of above cases, the moisture can be removed from the air.

Though not shown, a fan may be provided adjacent to each of the first, and second outlets 141, and 142. That is, fans may be provided to locations of the dampers, respectively.

In this case, by operating the fan on the first outlet 141 side, only the dry heated air of the middle temperature can be supplied, and by operating the fan on the second outlet 142 side, only the dry heated air of the high temperature can be supplied. Moreover, by operating both of the fans, the dry heated air both of the middle, and high temperatures can also be supplied.

However, if only one of the fans is operated, for an example, the fan on the first outlet 141 side is operated, the air will be introduced, not only through the inlet 143, but also through the second outlet 142, to impair efficiency.

In the meantime, though not shown, the inside space 11 of the cabinet shown in FIG. 1 may be divided into a plurality of spaces. Some of the plurality of spaces may have the heated air of the middle temperature supplied thereto, and the other spaces may have the heated air of the high temperature may be supplied. Such a mode can easily be understandable from refrigerators and clothes chests which are divided into a plurality of spaces with partitions. Detailed description of the mode will be omitted because persons skilled in the field of art can divide such a space very easily.

For an example, the cabinet may be provided with doors on opposite sides like a refrigerator having doors on opposite sides, and the inside space may also be divided oppositely. In this case, one side space will only be provided with the air of the high temperature, and the other side will only be provided with air of the middle temperature.

Therefore, different from the foregoing embodiment, according to the embodiment, specific designation of a temperature of the air to be supplied to one space is not necessary.

In the meantime, in the embodiment, the air both from the first and second outlets 141 and 142 is introduced into one inlet 143. For this, the divided spaces may be made to be in communication with one another, so that the air is introduced through the inlet, finally.

Moreover, it may also be possible that the divided spaces are made to be in communication with one another by means of ducts, so that the air is introduced through the inlet 143 via the ducts. Of curse, the ducts may be mounted to an inside wall of the cabinet or in a wall of the cabinet.

Because forms of such ducts can be implemented by persons skilled in the field of art, and are not related to technical aspect of the present invention, detailed description of the forms of the ducts will be omitted.

In the meantime, because the present invention is suitable to a clothing treating device, more particularly, to a refresher, it is preferable that the cabinet has coat hangers provided further therein.

Referring to FIG. 1, the laundry treating apparatus of the present invention supplies not only the heated air, but also the steam. It is preferable that the steam generator 20 is provided in the cabinet, and more preferably, at the lower portion of the inside space 11. Of course, a location of the steam generator 20 is not limited to this.

However, if the high temperature of the steam is taken into account, it is preferable that the steam generator 20 is provided to the lower portion of the inside space 11, because it is more preferable that the steam spray hole 21 is provided to the lower portion of the inside space 11.

That is, if the steam is sprayed from the steam spray hole 21 at the lower portion of the inside space 11, the high temperature air, lighter than surrounding air, will rise upward, enabling to supply the steam to the clothing in the inside space, more effectively.

However, a plurality of the steam spray holes 21 may be provided to an upper portion of the inside space, or sides of the inside space.

Or, the steam spray hole 21 may be provided to all of the plurality of spaces in the cabinet 10, or only to particular spaces. In this case, the particular spaces may be provided either with the heated air and the steam, or only with the steam.

In the meantime, in the present invention, it is not necessary that the heated air is provided in association with the steam without fail. Particularly, in a case clothing is dried in a humid weather, the clothing may be refreshed by providing the heated air only.

The heated air, lighter than surrounding air, will rise upward. Therefore, it is preferable that the heated air supply device 40 which supplies such heated air to the inside space is also provided to the lower portion of the inside space.

In the meantime, the cabinets in the foregoing embodiments may be clothes chests in bedrooms. In this case, it is preferable that the clothes chests are constructed of materials suitable for humid or high temperature environment. Of course, the clothes chests may be constructed of general wood, having a proper coat of film applied thereto.

### INDUSTRIAL APPLICABILITY

A laundry treating apparatus can be provided, which can supply heated air of various ranges.

A laundry treating apparatus can be provided, which can refresh clothing by supplying heated air as well as steam.

A laundry treating apparatus can be provided, which can be used not only for clothing of particular material, but also for clothing of any material.

A laundry treating apparatus can be provided, which can be manufactured and installed easily, and used conveniently, permitting to reduce product and installation costs.

Lastly, an inside space of the laundry treating apparatus may be divided, and heated air of temperatures different from one another may be supplied to the divided spaces respectively, permitting the user to treat the clothing according to a variety of refresh environments and various kinds of clothing.

1. A laundry treating apparatus comprising:
a cabinet having an inside space for holding clothing;
a steam generator provided to the cabinet for supplying steam to the inside space, selectively; and
a heated air supply device provided to the cabinet for making selective supply of air with at least three temperature ranges to the inside space.

2. The apparatus as claimed in claim 1, wherein the heated air supply device supplies air of a room temperature, and heated air of a middle temperature and a high temperature to the inside space, selectively.

3. The apparatus as claimed in claim 2, wherein, if the heated air supply device supplies air of the middle temperature, the heated air supply device supplies heated air of the middle temperature or dry heated air of the middle temperature, selectively.

4. The apparatus as claimed in claim 3, wherein, if the heated air supply device supplies air of the high temperature, the heated air supply device supplies dry heated air of the high temperature.

5. The apparatus as claimed in claim 4, wherein the heated air supply device includes;
a housing on one side of the cabinet for making selective communication with the inside space to form a flow passage of the air,
a condensing type heat pump in the housing, and
a heater for heating the air flowing along the flow passage.

6. The apparatus as claimed in claim 5, wherein the condensing type heat pump includes a compressor, a condenser, an expansion valve, and an evaporator, through which refrigerant circulates, wherein the evaporator and the condenser heat exchange with the air flowing along the flow passage.

7. The apparatus as claimed in claim 6, wherein the condensing type heat pump condenses moisture in the air introduced thereto at the evaporator to remove the moisture from the air, and heats the air introduced thereto at the condenser to the middle temperature.

8. The apparatus as claimed in claim 7, further comprising a condensing water tank for collecting and holding the condensed water condensed at the evaporator.

9. The apparatus as claimed in claim 8, wherein the condensed water collected and held in the condensed water tank is supplied to the steam generator.

10. The apparatus as claimed in claim 7, wherein, in a case the heated air is supplied to the inside space, the air introduced into the housing is heated at least by one of the condensing type heat pump and the heater before being supplied to the inside space.

11. The apparatus as claimed in claim 10, wherein the heated air supply device puts the heater into operation when the heated air supply device supplies the heated air of the middle temperature to the inside space.

12. The apparatus as claimed in claim 10, wherein, if the heated air supply device supplies dry heated air of the middle temperature to the inside space, the heated air supply device puts the condensing type heat pump into operation.

13. The apparatus as claimed in claim 10, wherein, if the heated air supply device supplies dry heated air of the high temperature to the inside space, the heated air supply device puts the condensing type heat pump and the heater into operation.

14. The apparatus as claimed in claim 5, further comprising a fan for making the air to flow along the flow passage.

15. The apparatus as claimed in claim 14, wherein the fan is located at a rear end of the condenser.

16. The apparatus as claimed in claim 14, wherein the fan is operated in a case the air of the room temperature is supplied to the inside space.

17. The apparatus as claimed in claim 5, wherein the housing has two or more than two outlets formed therein.

18. The apparatus as claimed in claim 17, wherein the two or more than two outlets supply air of temperature ranges different from each other.

19. The apparatus as claimed in claim 18, wherein the outlets include a first outlet for supplying dry heated air of the middle temperature, and a second outlet for supplying dry heated air of the high temperature.

20. The apparatus as claimed in claim 19, further comprising first, and second dampers for selective opening of the first, and second outlets.

21. The apparatus as claimed in claim 20, wherein the evaporator and the condenser are located at fore ends of the first, and second outlets of the flow passage respectively, and the heater is located adjacent to the second outlet.

22. The apparatus as claimed in claim 21, further comprising fan at the fore ends of the first and second outlets.

23. The apparatus as claimed in claim 22, wherein the first damper is opened, and the condensing type heat pump and the fan are operated in a case the dry heated air of the middle temperature is supplied through the first outlet.

24. The apparatus as claimed in claim 22, wherein the second damper is opened, and the condensing type heat pump, the fan, and the heater are operated in a case the dry heated air of the high temperature is supplied through the second outlet.

25. The apparatus as claimed in claim 17, wherein the inside space is divided into two or more than two spaces in correspondence to the two or more than two outlets.

26. The apparatus as claimed in claim 25, wherein the cabinet has doors on opposite sides, and the inside space is divided into a plurality of spaces in correspondence to the doors.

27. The apparatus as claimed in claim 26, wherein the dry heated air of the middle temperature is supplied to the space in correspondence to one side door and the dry heated air of the high temperature is supplied to the space in correspondence to the other side door.
